(19) United States
(12) Patent Application Publication
(10) Pub. No.: US 2012/0262338 A1
(43) Pub. Date: Oct. 18, 2012

(54) PROXIMITY MONITORING

(75) Inventor: Barry Hills, Kent (GB)

(73) Assignee: COWPER HOLDINGS, Road Town (VG)

(21) Appl. No.: 13/512,803

(22) PCT Filed: Dec. 10, 2010
(86) PCT No.: PCT/GB2010/052068

§ 371 Date: Jun. 27, 2012

(30) Foreign Application Priority Data
Dec. 11, 2009 (GB) 0921698.7

(51) Int. Cl. G01S 1/04

(52) U.S. Cl. 342/386

(57) ABSTRACT

Presented is a proximity monitoring apparatus and method. The apparatus comprises: a transmitter adapted to transmit a electromagnetic signal in a periodic time slot defined with reference to a master clock signal; and a detector adapted to receive the electromagnetic signal transmitted by the transmitter, to determine the period of the received electromagnetic signal, and to determine that the received electromagnetic signal was transmitted by the transmitter of the proximity monitoring apparatus if the determined period is within a predetermined range of values

The present invention relates to proximity monitoring.

In many application areas, particularly within the construction industry, people can come to harm through large movable machinery crushing them or striking them.

Traditional audio warning devices are often ineffective in alerting people of the proximity of machinery in noisy environments, particularly where the wearing of ear defenders may be a requirement. Other approaches to sensing moving objects involve continuous tracking of the positions of persons and/or machinery, but these suffer either from the expense of the tracking equipment or from the low reliability of the system due to the difficulty of determining the distance with the required accuracy to ensure a correct warning without issuing too many false alarms. This generates a need for a system that provides a cost-effective solution to the problem of providing warning to people in a reliable manner regarding multiple threats in the workplace, and without significant false alarms.

A requirement of the system is that it must allow for multiple vehicles or threats and multiple people moving continuously about within the defined workspace. Threats to the individual from each threat need to be independently tracked and enunciated. It is not acceptable for general warnings to be given as it is not obvious to whom the warning is being given, and over time they are ignored as they are ever present and are treated as background noise. Continuous or repeated multiple warnings also tend to be ignored over time. False alarms need to be minimised to avoid the warnings being ignored.

According to a first aspect of the invention, there is provided a proximity monitoring apparatus comprising: a transmitter adapted to transmit a electromagnetic signal in a periodic time slot defined with reference to a master clock signal; and a detector adapted to receive the electromagnetic signal transmitted by the transmitter, to determine the period of the received electromagnetic signal, and to determine that the received electromagnetic signal was transmitted by the transmitter of the proximity monitoring apparatus if the determined period is within a predetermined range of values.

Thus, proposed in a proximity detection system that may cater for multiple transmitters since each transmitter may be adapted to transmit a periodic pulse signal in a different time slot. Determination of a signal being transmitted by a transmitter of the proximity monitoring apparatus may therefore be based on whether or not the received signal repeats at an expected rate (i.e. has a period within a predetermined expected range of values). The reception of a further signal/pulse outside of such an expected windows may therefore be attributed to another transmitter of the proximity monitoring apparatus, and it may then be determined that the further signal was indeed transmitted by a further transmitter of the proximity monitoring apparatus by checking whether or not it also repeats at an expected rate (i.e. also has a period within the predetermined expected range of values).

Unlike prior proximity detection systems, a receiver according to an embodiment may detect and track multiple transmitters simultaneously, thereby tracking, identifying and/or warning of multiple concurrent threats.

Embodiments may utilise the propagation features associated with the near-field of an electromagnetic field to detect the proximity of an object carrying the transmitter.

According to another aspect of the invention, there is provided a detector for a proximity monitoring apparatus, the detector comprising: a receiver adapted to receive an electromagnetic signal transmitted by a transmitter of the proximity monitoring apparatus; and processing means adapted to determine if the received electronic signal is periodic, and to determine that the received electromagnetic signal was transmitted by the transmitter of the proximity monitoring apparatus if the period of a received periodic electromagnetic signal is within a predetermined range of values

According to yet another aspect of the invention, there is provided a transmitter for a proximity monitoring apparatus, the transmitter comprising: a processor having a local clock signal and adapted to generate an electromagnetic signal; synchronisation means adapted to synchronise the local clock signal with a master reference clock signal; and transmission means adapted to transmit the electromagnetic signal in a time slot defined with reference to the local clock signal.

Further developments of the invention are the subject-matter of the dependent claims.

An example of the invention will now be described with reference to the accompanying diagrams, in which:

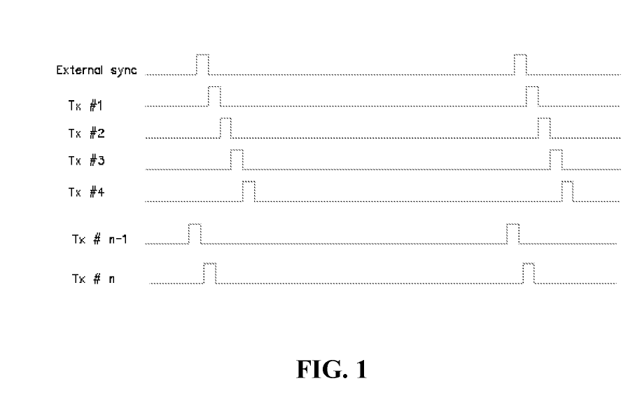

FIG. 1 illustrates Time Division Multiplexing (TDM) of transmitter RF pulses according to an embodiment of the invention; and

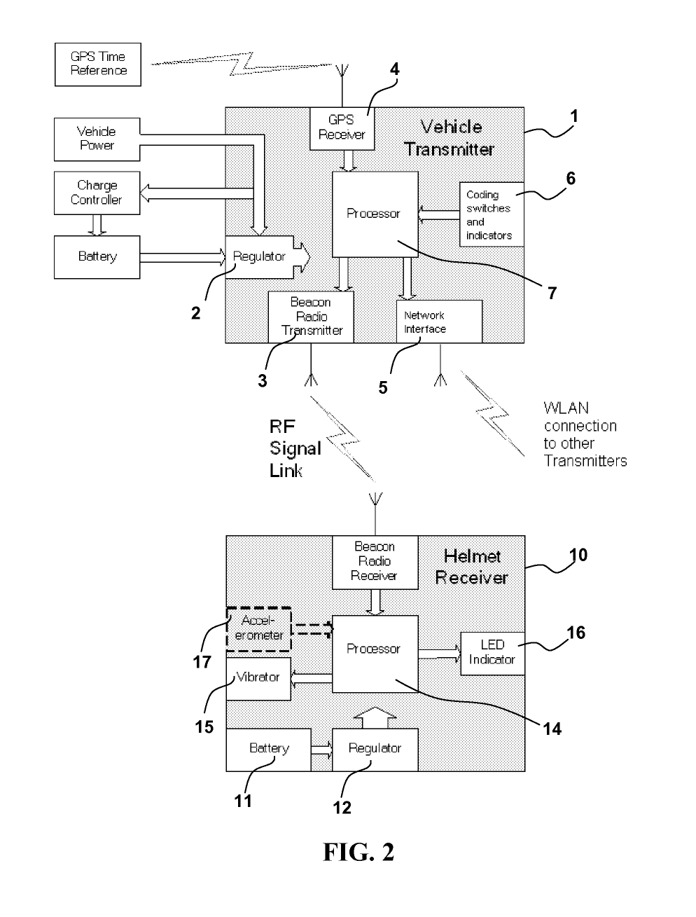

FIG. 2 is a block diagram of a proximity monitoring apparatus according to an embodiment.

Proposed is a proximity detection system that utilises the propagation features associated with the near-field of an electromagnetic field to detect the proximity of an object carrying the transmitting unit. The near field is the field close to the field source or the transmitter (i.e. less than one radian wavelength distance) and is contrasted with longer scale distances in which the normal, or far field, effects are seen. For the purposes of the current invention it is relevant to note that the primary near field effect that is of importance is the spatial field gradient—the rate of field attenuation with respect to distance between the transmitter and the receiver.

In other words, the near-field of an electromagnetic signal is the parts thereof extending from the transmitter to a distance not exceeding the radian wavelength thereof, wherein an electrical length of an electromagnetic signal is equal to its wavelength divided by 2π.

Proposed embodiments may comprise multiple transmitters and receivers. The transmitters are located in areas or on vehicles that are considered to pose a risk to personnel. Transmitters and associated antennas are calibrated to generate the desired protection zones around the vehicles or other threats.

Embodiments use synchronised time division multiplexing with strict time slots (as opposed to pseudo-random retransmits) and wide area synchronisation, whereby each transmitter has an allocated time slot in which it transmits a radio frequency (RF) pulse.

Referring to FIG. 1, Time Division Multiplexing (TDM) may be used to allocate the time slots within which the plurality of transmitters transmits a RF pulse. Each transmitter maintains an internal clock and synchronises this to an external reference clock. The external reference could be the Rugby time clock, a GPS derived clock, or a local private network generated synchronisation, for example.

Each Transmitter is allocated a slot 1 through n, where n is the maximum number of transmitters that can be tracked simultaneously by a receiver. This allocation may be by internal configuration switches, or dynamically over the private local network.

Each transmitter transmits its output pulse in an assigned time slot, and repeats this at a predetermined frame rate. For example, if the output pulse is 1 millisecond long, each timeslot is 2 milliseconds long and there are 125 slots assigned, the repetition rate (or period of repetition) for each transmitter is 125×2 milliseconds (or every 0.25 seconds). Each transmitter would thus be arranged to transmit a 1 millisecond pulse every 0.25 seconds for the first half of its assigned time slot.

A receiver according to an embodiment can distinguish one transmitter from another by time stamping each received valid pulse with an internally generated clock value based on an expected 0.25 second repetition rate (or period).

Synchronisation can be achieved in a number of ways. An exemplary way is to use an external broadcast time reference, for example a Global Positioning System (GPS) reference clock as a master reference clock. The system may then use a predetermined number of separate timeslots synchronised to the master reference clock. Each transmitter has a predefined time slot set by switches. A site log may then be used to ensure no two transmitters share the same timeslot. Each transmitter receives the broadcast synchronisation reference and only transmits in its assigned slot.

An alternative approach may be to use a Widearea Local Access Netork (WLAN) for communication between transmitters within a limited range (up to a few hundred metres) to provide both time synchronisation reference and dynamic assignment of timeslots to each transmitter by a common algorithm. If two transmitters detect a common slot assignment the one with an open slot next to it will drift into this new slot. The range of the WLAN may be sufficiently greater than the Low Frequency (LF) RF pulse used for measuring the distance between the transmitter and the receiver (typically 125 kHz and a few 10's of metres range) so that this occurs before the LF fields can mutually interfere.

Receivers are worn by personnel and provide a warning when the wearer enters a zone. Warnings to the wearer may be tactile or audio. Typically the receiver may be contained in a small case clipped to the head band of a safety helmet or garment. Vibrations issued by the receiver are transmitted directly to the body of the wearer providing a personal warning that is largely unaffected by ambient noise or the wearing of ear defenders. The detector can recognises individual transmitters using the knowledge that each transmitter transmits a periodic signal having a predetermined period, thus meaning received signals having the predetermined period originate from a transmitter of the system.

The system takes advantage of the inverse cube law relationship of field strength to distance to obtain accurate distance measurements.

The receivers track each potential threat separately when in range (a few 10's of metres maximum) and are capable of tracking multiple threats concurrently. When the threat is determined to be within a predetermined threat range a warning is given to the wearer. Once the warning has been generated, the receiver records this and does not issue more warnings for this particular threat, unless the threat moves out of range and reappears at a later time.

As an option the receiver can measure the rate at which the threat is closing and issue a warning at an appropriately increased range to allow adequate time for evasive action to be taken.

The alignment and positioning of the transmitter and receiver antennas is fundamental to the performance of the system.

For the transmitter the antenna needs to be placed on the vehicle (or other threat) so as not to overly affect the emitted field around the vehicle. If a single axis receiver is used the axis of the transmitter loop antenna needs to be vertical. The axis of the receiver antenna also needs to be mounted vertically. The transmitter antenna is optimally at the same height of the receiver. Variations due to axis or plane misalignment are mitigated somewhat due to the inverse cube law relationship of field strength to distance. If the receiver is worn on a helmet then the tendency of the wearer to keep the head near to vertical provides an acceptable alignment for the majority of the time.

If a three axis receiver design is used then the alignment of the antennas is not important and allows more flexibility in the installation of the transmitter antenna and the variations in the detected field due to head movement will be minimised.

A block diagram is shown in FIG. 1. The following text explains the roles of the various blocks.

Transmitter 1—The transmitter envisaged may comprise the following functional blocks that can be readily realised using widely available component elements to anyone skilled in the art.

Power Supply Regulator 2—This circuitry takes the vehicle or other supply voltage available and generates the necessary filtered and controlled internal voltage rails, and sequenced power on and off control signals.

Beacon Transmitter power output stage—This circuitry generates the coded 125 kHz RF pulse to the antenna. The code, length of pulse, modulation, output power level, and timing reference are determined by the controller processor circuitry and passed to the transmitter circuitry be an appropriate internal interface. The transmitter circuitry provides suitable local power rails to drive the antenna at the desired output power. This circuitry controls the current into the tuned antenna circuitry to achieve the desired power output and controlled turn on and off profiles to minimised unwanted spurious emissions

Beacon transmitter Antenna circuitry 3—This circuitry comprises a wire loop antenna and tuning circuitry. The dimensions of the wire loop antenna and the output drive current determine the effective protection zone associated with the Transmitter installation. The tuning circuitry allows the installation to be optimised for external factors affecting the resonant frequency to the antenna coil and maximise the power transmitted.

GPS receiver circuitry and associated antenna 4—This chipset and associated antenna provides the controller processor with the geographical location of the transmitter and an accurate timing reference. This timing reference is used by the controller to maintain synchronisation with other transmitters and remain within its designated time slot. The geographical information may be used to log the vehicle location at any time.

Network interface 5—This interface may be realised using a IEEE 802.11 style interface or similar WiFi WLAN standard depending on exactly how the local transmitter support network is to be configured. With correct antenna selection this is capable of giving a range of a few hundred metres. The specific implementation of this interface is not critical to the invention. The function of this interface is to provide the ability to negotiate the allocated transmitter time slots, and to provide synchronisation to maintain the time reference to maintain these slots. This interface also allows for remote antenna tuning and output power control for the transmitter. It also allows for maintenance and the passing off other useful data between units and network hubs. The network may be Peer to Peer or hub based depending on site demands. In the absence of a WiFi network connection these functions are realised using the local hardware interface.

Local hardware interface and coding switches 6—This circuitry allows the functions identified in the network section to be realised in the absence of a WiFi network. It also allows for shop based diagnostics and programming. Local indicators provide unit status in the absence of the network connection.

Controller processor 7—This circuitry is micro controller based with bespoke software and controls the overall function of the unit and the interfaces as identified above.

Receiver 10—The receiver envisaged may comprise the following functional blocks that can be readily realised using widely available component elements to anyone skilled in the art.

Internal battery 11 and regulator 12 provide suitable power for the receiver circuitry, processor, and annuciators sufficient to allow continuous operation over an extended period once activated. There is no OFF switch to avoid the unit being inadvertently deactivated.

Beacon radio receiver 13 comprises an LC circuit using an inductor with a ferrite core tuned to resonate at the carrier frequency (nominally 125 kHz), pre amplifier stages with filtering the remove unwanted frequencies and amplify the pulse, a detector to “wake up” the processor, and a peak detection circuit to allow the magnitude of the pulse to be determined. The circuitry can use a single axis receiver aligned approximately in the same axis and plane of the transmitting antenna, or preferably a 3 axis arrangement whereby the total field strength can be determined as the root of the sum of the squares of the three orthogonal receivers. This latter arrangement does not suffer from the reduced signal received due to misalignments of the receiving and transmitting antenna but does require additional receiver channels. Any of these channels can “wake” the processor and all are fed to the processor for computation as described above.

The control processor 14 with its software analyses the received signals, determines their validity and magnitude, and processes this information to provide tactile and visual indications via the vibrator and indicator outputs.

Vibrator 15 and LED 16 indicator provide tactile and visual confirmation of warning, unit health and battery condition.

The accelerometer 17 is provisioned for detecting excessive inclination of the receiver antenna to the vertical so appropriate corrections can be applied for a single axis receiver version.

1-16. (canceled)

17. A detector for a proximity monitoring apparatus, the detector comprising:
a receiver adapted to receive an electromagnetic signal transmitted by a transmitter of the proximity monitoring apparatus; and
a processing element adapted to determine if the received electronic signal is periodic, and to determine that the received electromagnetic signal was transmitted by the transmitter of the proximity monitoring apparatus if the period of a received periodic electromagnetic signal is within a predetermined range of values.

18. A detector according to claim 17, further arranged to determine separation between the receiver and the transmitter according to a measure of near-field of the received electromagnetic signal.

19. A detector according to claim 18, further arranged to determine a rate of change of separation between the receiver and the transmitter.

20. A detector according to claim 18 including an indicator element arranged to generate a first indicator signal when the detector has determined that the separation between the receiver and the transmitter is less than a predetermined distance.

21. A detector according to claim 19 including an indicator element arranged to generate a first indicator signal when the detector has determined that the separation between the receiver and the transmitter is less than a predetermined distance.

22. A detector according to claim 21, wherein the indicator element is arranged to generate a second indicator signal when the detector has determined that the rate of change of the separation between the receiver and the transmitter is greater than a predetermined value.

23. A detector according to claim 21, wherein the indicator element comprises a vibration element adapted to generate a user-perceptible vibration signal.

24. A detector according to claim 23, wherein the indicator element comprises a vibration element adapted to generate a user-perceptible vibration signal.

25. A detector according to claim 22, wherein the indicator element is arranged to record that a first indicator signal has been generated and to refrain from generating a further first indicator signal until the detector has determined that the separation between the receiver and the transmitter exceeds the predetermined distance.

26. A detector according to claim 17, including an attachment element arranged to attach the detector to an item of apparel of a user in normal use.

27. A detector according to claim 18 in which the near-field of the electromagnetic signal comprises a portion of the transmitted electromagnetic signal extending from the transmitter to a distance not exceeding a radian wavelength of the transmitted electromagnetic signal, wherein an electrical length of the transmitted electromagnetic signal is equal to a wavelength of the transmitted electromagnetic signal divided by 2π.

28. A hat or other apparel comprising a detector according to claim 17.

29. A transmitter for a proximity monitoring apparatus, the transmitter comprising:
a processor comprising a local clock signal and adapted to generate an electromagnetic signal;
a synchronization element adapted to synchronize the local clock signal with a master reference clock signal; and
a transmission element adapted to transmit the electromagnetic signal in a time slot defined with reference to the local clock signal.

30. A transmitter according to claim 29, wherein the transmitter further comprises a GPS receiver adapted to receive a GPS signal comprising the master reference clock signal.

31. A transmitter according to claim 29, further comprising a communication interface adapted to establish a communication link with another transmitter of the proximity monitoring apparatus, and wherein the transmitter is adapted to allocate the time slot by communicating with the other transmitter via the communication link.

32. A transmitter according to claim 29, further comprising a user interface adapted to receive a user input, and wherein the transmitter is adapted to allocate the time slot based on the received user input.

33. A transmitter according to claim 30, further comprising a user interface adapted to receive a user input, and wherein the transmitter is adapted to allocate the time slot based on the received user input.

34. A transmitter according to claim 31, further comprising a user interface adapted to receive a user input, and wherein the transmitter is adapted to allocate the time slot based on the received user input.

35. A transmitter according to claim 29, including an attachment element arranged to attach the transmitter to a vehicle or item of machinery.

36. A proximity monitoring apparatus comprising:
a transmitter adapted to transmit an electromagnetic signal in a periodic time slot defined with reference to a master clock signal; and
a detector adapted to receive the electromagnetic signal transmitted by the transmitter, to determine a period of the received electromagnetic signal, and to determine that the received electromagnetic signal was transmitted by the transmitter of the proximity monitoring apparatus if the determined period is within a predetermined range of values.
